(19) United States
(12) Patent Application Publication
(10) Pub. No.: US 2016/0240069 A1
(43) Pub. Date: Aug. 18, 2016

(54) SYSTEM HAVING LOCATION BASED PROXIMITY FEATURES AND METHOD THEREFOR

(71) Applicant: PABLO ALBERTO LARRIVIERE, LOS ANGELES, CA (US)

(72) Inventor: PABLO ALBERTO LARRIVIERE, LOS ANGELES, CA (US)

(21) Appl. No.: 15/139,041

(22) Filed: Apr. 26, 2016

Related U.S. Application Data
(62) Division of application No. 14/460,096, filed on Aug. 14, 2014.

(51) Int. Cl. G08B 21/24; H04M 1/725; H04M 1/04; H04B 1/3888; H04M 1/11

(52) U.S. Cl. CPC G08B 21/24; H04B 1/3888; H04M 1/11; H04M 1/04; H04M 1/72527; H04M 1/185

(57) ABSTRACT

The present application discloses a device cover having an actuator triggering a message provided to an output device when the actuator is activated. The message can be a prerecorded message or dynamically stored message. In one embodiment, the device cover can provide warnings. In another embodiment, the device cover can be coupled with a holder to enable a loss prevention system whereby a disconnected cover would provide the activation request.

### BACKGROUND

Over the last decade, personal devices have become the fastest growing segment of electronics. Personal devices can not only combine wireless calling capabilities but can also provide functions which have been traditionally limited to desktop computers. Personal device makers such as Samsung and Apple have become key players in this market. These companies have developed new technologies with bigger screens and more computing power taking the user experience outside those limitations associated with standalone electronics.

These personal devices have become quite expensive so protecting them has become equally important. A number of covers exist to protect and enclose these types of personal devices. These covers protect the personal devices from bumps, drops, scratches, and rough handling. A number of providers such as OtterBox specialize in the area of making the covers.

These covers can be made from a variety of materials. Some cases are made of metal such that the frame of the personal device does not get damaged when dropped. Other types of cases can be made of plastic which are typically cheaper in price. Plastic and rubber composites are also preferred choices of personal device cover makers. Some covers protect the entire personal device, while others protect portions of them.

These covers nevertheless lack functionality and merely provide protection or enclose the personal devices. Accordingly, what is needed is a cover with functionalities and not limiting the cover to a mere protective or enclosing implement.

### BRIEF DESCRIPTION

According to one aspect, a device cover is provided. The device cover can include an actuator triggering a message provided to an output device when the actuator is activated.

According to another aspect, a personal device cover having a switch, a speaker, and memory storing a sound file is provided. The personal device cover can include a processor and an activation module that causes the processor to detect actuation of the switch, retrieve the sound file within the memory, and play the sound file through the speaker.

According to a further aspect, a system is provided. The system can include a cover for a personal device, a holder securing the personal device through the cover, and an activation module providing an alarm when the cover and holder are disconnected.

### BRIEF DESCRIPTION OF THE DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objects and advances thereof, will be best understood by reference to the following detailed description of illustrative embodiments when read in conjunction with the accompanying drawings, wherein:

FIG. 1 is an exemplary schematic showing placement of a personal device into a cover having features described herein in accordance with one aspect of the present application;

FIG. 2 is an exemplary diagram showing components placed within the cover in accordance with one aspect of the present application;

FIG. 3 is an exemplary diagram showing the components in FIG. 2 placed within the cover in accordance with one aspect of the present application;

FIGS. 4A through 4C are illustrative actuators to provide features for the cover in accordance with one aspect of the present application;

FIG. 5 is an exemplary diagram showing placement of illustrative actuators within the cover in accordance with one aspect of the present application;

FIG. 6 is a flow chart showing illustrative processes for actuating functions within the cover in accordance with one aspect of the present application;

FIG. 7 is an exemplary diagram showing opening the cover to provide a warning message in accordance with one aspect of the present application;

FIG. 8 is a flow chart showing illustrative processes for providing the warning message in accordance with one aspect of the present application;

FIG. 9 is an exemplary schematic showing placement of a personal device having a cover into a clip in accordance with one aspect of the present application; and

FIG. 10 is an exemplary schematic showing illustrative sensors for providing a phone reminder in accordance with one aspect of the present application.

### DETAILED DESCRIPTION

The following includes definitions of selected terms employed herein. The definitions include various examples and/or forms of components that fall within the scope of a term and that can be used for implementation. The examples are not intended to be limiting. Further, one having ordinary skill in the art will appreciate that the components discussed herein, can be combined, omitted or organized with other components or into organized into different architectures.

Generally described, the present application discloses a cover for a personal device that can provide a simulated ring tone and/or conversation afterwards. The device cover can include at least one actuator and an output device. An activation request can be provided through the at least one actuator and in response to the request, a response is provided through the output device. The response can be a pre-recorded message or dynamic message, which can correspond to the simulated ring tone. In one embodiment, the device can provide warnings to unauthorized users. In another embodiment, the device cover can also be coupled with a holder to enable a loss prevention system whereby a disconnected cover would provide the activation request.

As will become apparent from the embodiments below, a number of advantages can be provided by cover. For example, phone calls or simulated phone conversations to repel unwanted invitations can be provided. Furthermore, a number of comical messages can be provided adding entertainment value to a what-used-to-be a boring cover. Alerts and detractors can be given through the cover as warnings. In addition, the cover can notify a forgetful user of a misplaced or left behind phone. Further advantages will become apparent from the description provided below.

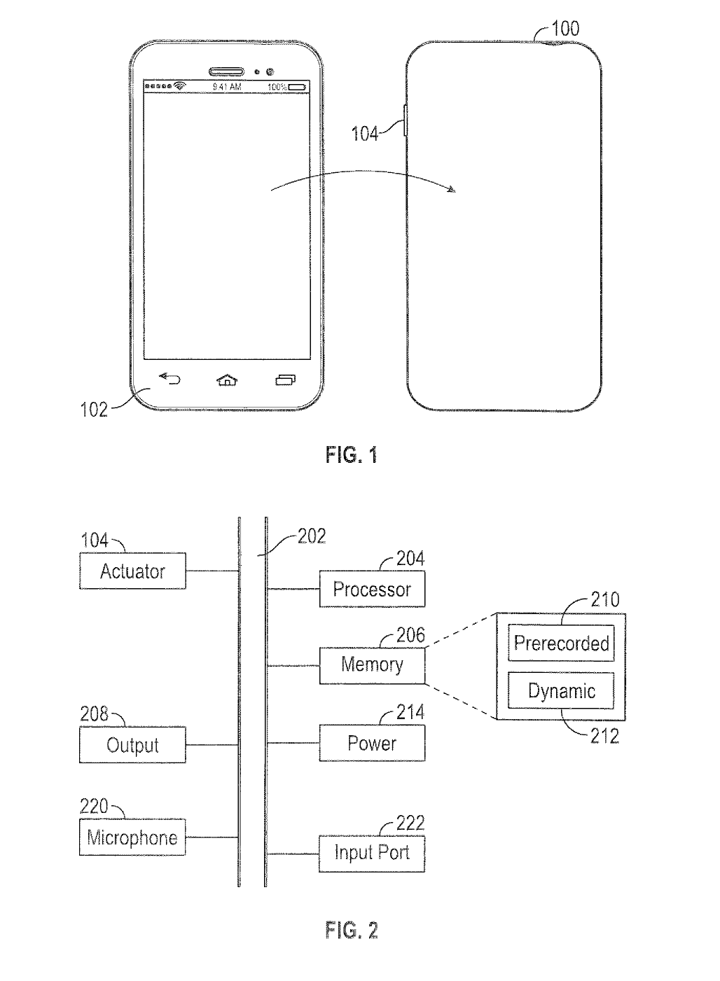

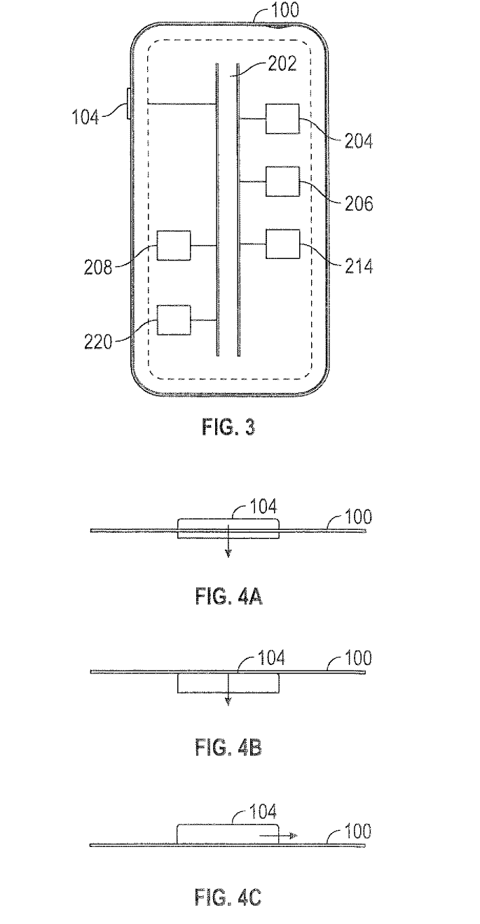

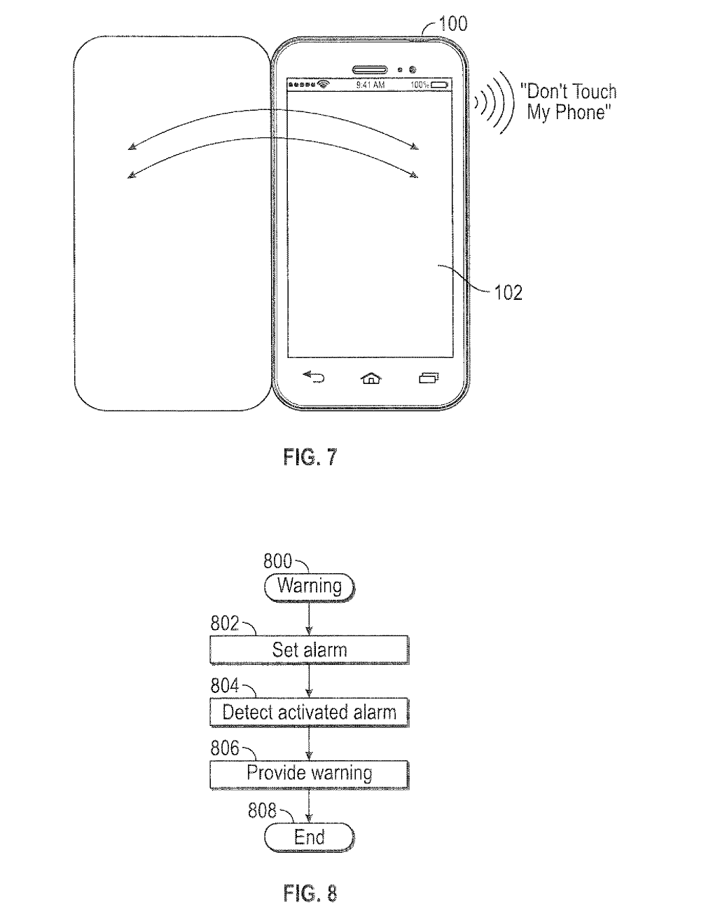

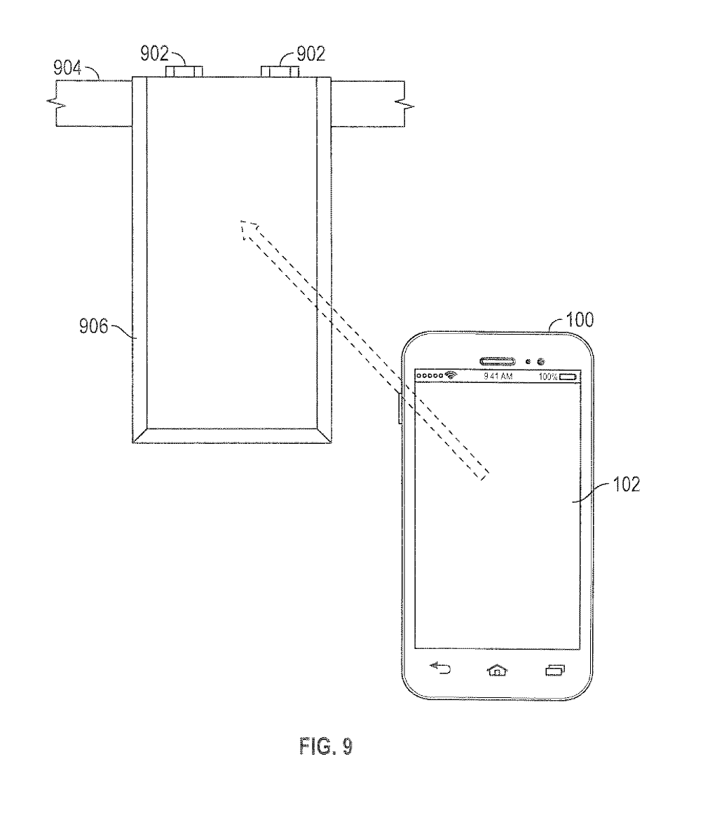

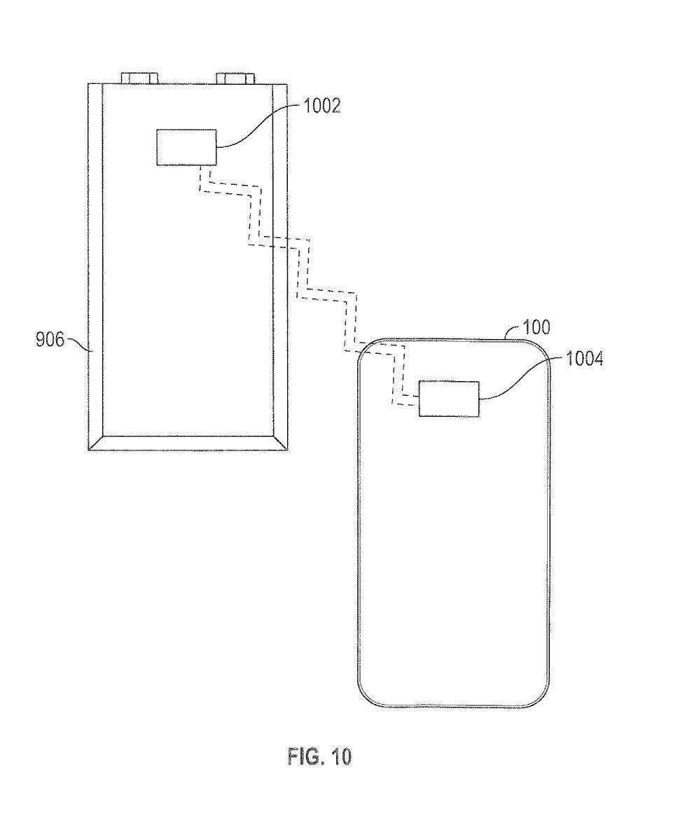

An exemplary system showing a personal device coupled with the cover is shown in FIG. 1. The components of the cover are provided in FIGS. 2 and 3. FIGS. 4A through 4C, 5, and 6 depict different actuation/activation devices and methods for the system. FIGS. 7 and 8 provide a cover of a personal device allowing a warning for unauthorized users. FIGS. 9 and 10 depict a unique cover in combination with a holder to notify a user of a disconnected personal device. The covers can come in a variety of different configurations. Those shown in the FIGURES are for illustrative purposes and should not be construed as limiting to the present application.

Referring now to FIG. 1, an exemplary schematic showing placement of a personal device 102 into a cover 100 having features described herein in accordance with one aspect of the present application is provided. The personal devices 102 can include a personal digital assistant (PDA), smartphone, flip phone, tablet, desktop, laptop computer, gaming device, etc. Personal devices 102 can be produced from a number of manufacturers including Samsung, Apple, Blackberry, and LG, to name a few. While shown as having smartphone dimensions and features, personal devices 102 come in a number of configurations including having larger or smaller screens and different dimensions. The cover 100 protecting the personal device can also conform to these configurations.

The cover 100 can be referred to, but not limited to, a protective covering, case, protector, box, and enclosure. The cover 100 can protect the personal device 102 but does not necessarily have to, for example, the cover 100 can provide pure aesthetic values to a personal device 102. The cover 100 can be snapped onto the device 102 or enclose the personal device 102. Fasteners can also be used to secure the cover 100 to the personal device 102, for example, hook and loop fasteners. The cover 100 can completely enclose the personal device 102, for example, create a waterproof seal around the personal device, or the cover 100 can partially surround the personal device 102.

As will be described in further detail below, an actuator 104 can also be provided on the cover 100 (although it does not necessarily have to be) and can be used to provide a request for a message to be played from the cover 100. The actuator 104 can be referred to as a switch, activator, shifter, button or the like. The actuator 104 can be placed on a variety of locations on the cover 100 and is not limited to the position shown in FIG. 1. The actuator 104 can be used to activate a request for playing a sound, lighting the cover 100, vibrating the cover 100, or a combination thereof as will become apparent from the discussion below. The actuator 104 can be triggered through a simple press, sliding motion or general activation method to implement the functions of the cover 100. In one embodiment, the actuator 104 can be a hook, or the like, that when disconnected from the cover 100 can activate the playing of a message or other output method which will be described below. The actuator 104 can be concealed. In the embodiment, for the simulated call, it would be desirable to not have the actuators 104 exposed, i.e., concealing them.

FIG. 2 is an exemplary diagram showing components placed within the cover 100 in accordance with one aspect of the present application. Additional or fewer components can be used depending on those features a user intends to have on their cover 100. All or a portion of the components can be within or outside of the cover 100. As shown, the cover 100 can include a bus 202, at least one processor 204, memory 206, output device 208, power supply 214, microphone, and input port 222. The memory can include prerecorded message 210 or dynamic messages 212.

The bus 202 can refer to an interconnected architecture that is operably connected to connect components within the cover 100. The bus 202 can be used to transfer data between the components within or outside the cover 100. The bus 202 can communicate with various devices, modules, logics, and peripherals using other buses. The bus 202 can be a single internal bus interconnect architecture and/or other bus or mesh architectures (e.g., external). The bus 202 can be a memory bus, a memory controller, a peripheral bus, an external bus, a crossbar switch, and/or a local bus, among others. In some embodiments, the bus 202 can interconnect components inside the cover 100 using protocols such as Controller Area network (CAN), Local Interconnect Network (LIN), among others. Near field communications (NFC) as well as wireless can be adapted into the cover 100 through the bus 202.

The processor 204 can process. Signals processed by the processor 204 can include digital signals, data signals, computer instructions, processor instructions, messages, a bit, a bit stream, or other means that can be received, transmitted and/or detected. Generally, the processor 204 can be a variety of various processors including multiple single and multicore processors and co-processors and other multiple single and multicore processor and co-processor architectures. The processor 204 can include various modules to execute various functions.

Coupled to the bus 202 is the memory 206. The memory 206 can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory 206 can store an operating system that controls or allocates resources of a computing device.

Pre-recorded messages 210 can be placed within the memory 206 as shown in FIG. 2. These pre-recorded messages 210 can vary depending on the user of the cover 100. In one embodiment, different pre-recorded messages 210 can be activated depending on different actuators 104. For example, one actuator 104 can provide a simulated phone ring while another actuator 104 allows for a simulated voice of an interlocutor. Different languages can be used in the simulated conversation based on a user's preference. In one embodiment, warning sounds can be stored in the pre-recorded messages 210. When an unauthorized user opens the cover 100 or presses the actuator 104 the warning sound can be provided. Alternatively, a siren can be used when the cover 100 is disconnected from a holder which activates the actuator 104.

For dynamic messages 212, these can be stored by the user into memory 206. In one example, a microphone 220 located on the cover 100 can be used to take in sound. The sound can be captured and stored into a dynamic message 212. The sound can be captured into sound bites and stored into dynamic messages 212. Sound bites can be stored digitally or through analog methods. In one embodiment, to store a dynamic message 212, the user would hold on or continuously press the actuator 104. The user can also press the actuator 104 a predetermined amount of times within a set time period to record and then store the dynamic message 212. Other methods can be used for storing the dynamic message 212 such as having a separate input button, which has not been shown, that would allow such dynamic messages 212 to be recorded.

The pre-recorded message 210 or dynamic message 212 can also include a delay. For example, when the user activates the actuator 104 of the cover 100, a predetermined delay can be provided and then the message 210 and/or 212 can be played. The delay can be provided as part of the message 210 and/or 212 or delay circuits can be used to delay the message 210 and/or 212. In one embodiment, the delay can be set to thirty seconds. The delay for the message 210 and/or 212 can also be programmed by the user.

In one embodiment, multiple actuators 104 can be used to retrieve pre-recorded messages 210 and/or dynamic messages 212. Each actuator 104 can correspond to a different message 210 and/or 212. For example, the personal device cover 100 can have three actuators 104. A first actuator 104 can activate a warning message 210 and/or 212, a second actuator 104 can activate a predetermined message 210, and a third actuator 104 can activate a dynamically stored message 212. A number of different combinations of using actuators 104 and different messages 210 and/or 212 can be used. The actuator 104 typically can be an external button, an embedded button, switch or light sensor according to one embodiment.

In one embodiment, the dynamic messages 212 can be received through other input devices alternatively, or in addition, to the microphone 220. For example, a keyboard, pointing and selection device, cameras, images devices, video cards, disks, network devices, among others can be used to input the dynamic messages 212. Text-to-sound can also be used to convert input into sound bites.

In one embodiment, the dynamically stored message 212 can be received through an input port 222 that can be provided in addition to the microphone 220 or separately thereform. A memory device can be connected to the cover 100 through a USB connection. The memory device can store sound bites which can be transferred into memory 206 and specifically, as a dynamic message 212. The input port 222 can also receive sound bites through wireline communications where a computer can be connected to the cover 100 and messages 212 can be received from the computer. A user interface, which can be graphical, can be provided such that messages can be easily stored into memory 206. The user interface can be provided through a connected computer. In one embodiment, the personal device 102 can be used to provide dynamically stored messages 212 through the input port 222 or through other methods.

Now describing the output device 208 of FIG. 2, once a message 210 and/or 212 has been retrieved, it can be provided as output. Beforehand, the output was described as messages 210 and/or 212 in the form of sound bites. The output, however, can be provided in different forms. For example, the output device 208 can be a vibrator, sound, light, or combination thereof. Other output mechanisms can be used for example, a display on the cover 100. In one embodiment, the output can be provided through the connected personal device 102 via a wireline or wireless connection. A screen, vibrator, speaker of the personal device 102 can be used as the output device.

The cover 100 can also have its own power source or be connected to an alternative power source such as the personal device 102. The power 214 can come from at least one battery fitted within the cover 100 or receive wireless power from the personal device 102. The power source 214 can come from solar or from a variety of other sources.

As shown in FIG. 2, the memory 206 can have both pre-recorded messages 210 and dynamic messages 212. The cover 100 can include one or the other and is not limited to having both. A representative scenario for providing the messages 210 and/or 212 can include an actuator 104 press or activation. The processor 204 can then trigger a reading of instructions within memory 206 and then retrieve the appropriate message 210 and/or 212. The messages can be played on the output device 208.

Alternatively, and in one embodiment, the processor 204 can be removed. A trigger of the actuator 104 can cause the message to be activated without a message lookup in the memory 206. When enabled, the actuator 104 can simply trigger a message provided to the output device 208. No message would be retrieved, rather the message would simply be played. In one embodiment, this can occur through the contact of two simple mechanical pieces which when contacted together would play the message 210 and/or 212.

A button (not shown) can also be provided on the cover 100 that would disable the actuator 104 or the system itself. For example, this mechanism can use switch logic that would discontinue any signal provided by the actuator 104. In one embodiment, the disable button can be inside or outside of the cover 100. Alternatively, the button can be completely off the cover 100, for example, the personal device 102 can be used to disable the functions and features of the cover 100. The system can be disconnected through the use of a button, switch, or other deactivation methods. Furthermore, the deactivator can be used to prevent the messages 210 and/or 212, warnings, alarms, or other output from being provided.

Turning now to FIG. 3, an exemplary diagram showing the components in FIG. 2 placed within the cover 100 in accordance with one aspect of the present application is provided. Typically, the components can be relatively light and thin so they fit within the cover 100. The components, such as those shown (bus 202, processor 204, memory 206, output device 208 and power 214, microphone 220) can be placed relatively flat in the back of the cover 100. Alternatively, the components can be placed in a variety of locations within the cover 100, for example, the sides, top and bottom. The actuator 104, in one configuration, can be tied to the bus 202. The placement of those components shown in FIG. 3 represent one setup, but it should not be limited to such.

FIGS. 4A through 4C are illustrative actuators 104 for the cover 100 in accordance with one aspect of the present application. FIG. 4A, representing one embodiment, shows a push button type of implement to trigger the actuator 104. The push button 104 can start at a location above the cover 100 and end at the cover 100 when pressed. A spring or the like can be used to return the button 104 to its original form after the user releases their finger.

FIG. 4B shows an exemplary actuator 104 that also includes a push button. However, the push button 104 as shown is below the cover 104 and when pressed goes below the cover 100. Similar to before, the push button 104 can return to its normal position with a spring. FIG. 4C depicts a switch for the actuator 104. The switch 104 can be slid back and forth to activate the features of the cover 100.

The previous embodiments depicted one actuator 104, however, the cover 100 can include multiple actuators 104. Each actuator 104 can provide different messages or outputs to the output device 104 (or output devices 104). For example, one actuator 104 can trigger a pre-recorded message 210, a second actuator 104 can activate a dynamic message 212, and a third actuator 104 can provide another output such as vibration, light or combination thereof. Different features will become apparent with multiple actuators 104 as described below.

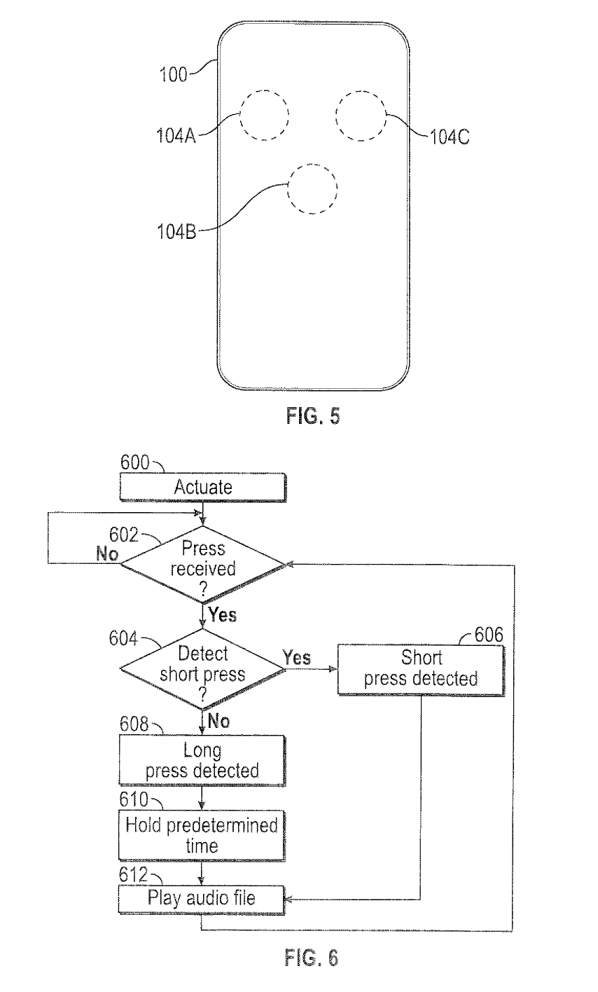

FIG. 5 is an exemplary diagram showing placement of illustrative actuators 104A, 104B, and 104C within the cover 100 in accordance with one aspect of the present application. Placement of the actuators 104A, 104B, and 104C can be provided at most points on the cover 100. For example, the actuators 104A, 104B, and 104C can be placed on the sides, top, and bottom in addition to the back of the cover 100.

A typical scenario for the actuators 104 to trigger a message 210 and/or 212 can begin with a push button 104 press on the outside cover 100. The trigger from the actuator 104 can be provided over the bus 202 to the processor 204. Alternatively, the actuator 104 can directly trigger the output to the output device 208 whereby an immediate message 210 and/or 212 is provided. When the processor 204 receives the signal, it can detect which message 210 and/or 212 to retrieve, if more than one message 210 and/or 212 is available. Depending if the cover 100 has more than one actuator 104 or how the actuator 104 is pressed, different messages 210 and/or 212 can be retrieved. Furthermore, the messages 210 and/or 212 do not have to be sound bites, rather they can be provided as output in the form of vibrations, sounds, lights, or a combination thereof. Thereafter, the appropriate output is directed to the output device 208.

A number of different configurations can be realized through having actuators 104 for triggering messages 210 and/or 212, or other output, to an output device 208. One such configuration is illustrated in FIG. 6 which provides a flow chart showing illustrative processes for actuating functions within the cover 100. The process can begin at block 600. At block 602, a determination is made whether the actuator 104 receives a press or some other activation method. If no activation is received, the process goes back to block 602.

At block 604, and if a press or other activation method is received, a determination is made on whether a short press has been received. In this embodiment, the cover 100 can distinguish different functions using a long press and a short press. In this process 600, the long press/short press can differentiate a delayed time in the message. One advantage of the shown process 600 would be to allow someone to remove the awkwardness of having the output device 208 activate immediately after the actuator 104 is activated. Other functions can be realized through short/long presses, for example, retrieving pre-recorded messages 210 or dynamic messages 212.

If a short press is detected at block 604, the audio file would be played at block 612 and the cover 100 would wait for another press at block 602. In the alternative, at block 608 a long press can be detected. A long press, in accordance with one embodiment, can indicate that the user wishes for a delay to occur. At block 610 this delay can occur. The delay can be a predetermined time or can be set by the user. Alternatively, the delay can be set by the user through a variety of methods, for example, the input port 222 shown in FIG. 2 can be used to set the delay period. The sound bite, or other output described above, can be played at block 612. The processes can return to block 602.

In other embodiments, a hard press or multiple presses can provide different functions for the cover 100. For example, multiple presses can cause the cover 100 to store a new message into memory 206 loading it into a dynamic message 212. Dynamic messages 212 can be stored in addition to other messages 212 or can be rewritten over one another. Sequences of actuator 104 presses can be used to select which message 212 to write over or which slot to place the message 212 into. Other functions can include setting which type of output the user wishes to provide, for example, sound, vibrating, or light which can be changed via the actuators 104 or separate buttons located on the cover 100.

As briefly described above, and provided in more detail now, the cover 100 can be used to provide warnings to those who are unauthorized to open the cover or use the phone. Alternatively, a warning can be provided to those who open the cover 100 without the permission of the owner. FIG. 7 is an exemplary diagram showing opening the cover 100 to provide a warning message 210 and/or 212 in accordance with one aspect of the present application.

The actuator 104 can be triggered by opening the cover 100 and exposing the personal device 102. In a typical process, the actuator 104 would be triggered by the opening, which would cause the message 210 and/or 212 to be sent through the output device 208. This can occur with or without the processor 204 as described above. The message 210 and/or 212 can include the phrase “Don't touch my phone”, “Go away”, or “Leave my phone alone.” In one embodiment, light, sound, vibrations, or a combination thereof can be used.

In one embodiment, the actuator 104 can be on the personal device 102. The triggering of the actuator would send the message 210 and/or 212 to the output device 208 on the cover 100. For example, if a user opens or starts the personal device 102, the signal could be sent via the input port 222 to the processor 204 or the output device 208 directly.

A button, similar to the one described above, can be used to deactivate the warning system. The button can be used to turn on/off the warning system. The button can be placed on the cover 100 or can be accessed through the personal device 102. In one embodiment, the personal device 102 could provide an application that would allow the user to turn on/off the actuator 104 thereby preventing the output. Typically, the button would be hard to locate by a person accessing the cover 100 or the personal device 102.

Turning to FIG. 8, a flow chart showing illustrative processes for providing the warning message in accordance with one aspect of the present application is depicted. This represents one process, but not the only process for providing warnings or alarms. The processes can begin at block 800. At block 802, a user can set the alarm/warning system through the use of a button, switch or other activation method.

At block 804, the cover 100 can detect an activated alarm. For example, and as shown in FIG. 7, the cover 100 is opened triggering the actuator 104. Alternatively, a user press on a key on the personal device 104 could trigger an actuator 104. At block 806, the warning can be provided through the output device 208 of the cover 100 or through other output methods on the personal device 102. One advantage of the cover 100 can be to deter malicious attempts to access data or personal information in the personal device 102.

Turning now to another embodiment of the cover 100, FIG. 9 is an exemplary schematic showing placement of a personal device 102 having a cover 100 into a clip 906 in accordance with one aspect of the present application. The cover 100 of the shown system can be used to alert a user of a misplaced, lost, or left personal device 102. As will become apparent, an advantage of the shown system allows a user to be notified that their phone is misplaced while not leaving the premises. Further, the system would give the user quick notification if their personal device 102 has been disconnected from their body if not in use.

The clip 906 of the system can also be referred to as a holder, securing mechanism, holster, or the like. The purpose of the clip 906 is to secure the cover 100 which in turn protects or encloses the personal device 102. When the clip 906 no longer detects the cover 100, an alert/warning can be provided. Bringing the components of the previous FIGURES, the actuator 104 can be the triggering mechanism that would provide the alarm. For example, when the clip 906 does not sense the cover 100 or vice versa, the alarm can be provided.

The warning/alarm is typically not immediately activated. The warning/alarm can be provided through the output device 208 on the cover 100 or alternatively, on the clip 906 itself. A personal device 102 reminder can be provided if a number of conditions are present. For example, the system would not be activated if the personal device 102 is in use. Furthermore, a predetermined or user set time can be allowed to elapse before a warning is provided. A combination of whether the clip 906 is connected to the cover 100, whether the phone is in use and whether a predetermined time has passed can be used to determine whether to provide the warning. Other factors that can be used to determine whether to activate the alarm could include, but are not limited to, whether the personal device 102 is charging and/or whether the personal device 102 is within a certain distance of the clip 906.

The clip 906 can include additional components. For example, the clip 906 can include fasteners 902. These fasteners 902 can be used to connect the clip 906 to a user, for example, through a user's belt 904. Other attachment mechanisms and methods can be used to secure the clip 906 to the user. These can include hook and loop fasteners, plastic fasteners, or the like.

In a typical activation method, an actuator 104 can be activated by an involuntary action of the user, such as detaching the personal device 102 from the clip 906 by accident, or by a non-suspecting, non-authorized user of the cover 100. The trigger by the actuator 104 causes either processor 204 to provide output or the direct connection to the output device 208 as described above.

FIG. 10 is an exemplary schematic showing illustrative sensors 1002 and 1004 for providing a phone reminder in accordance with one aspect of the present application. While shown as a phone, the embodiment can represent any personal device 102. The sensors 1002 and 1004 could be used to detect the detachment of the cover 100 from the clip 906. Those processes described above can then be used to determine whether to activate the output device 208.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

The data structures and code, in which the present application can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this application that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

It will be appreciated that various implementations of the above-disclosed and other features and functions, or alternatives or varieties thereof, can be desirably combined into many other different systems or applications. Also that various presently unforeseen or unanticipated alternatives, modifications, variations or improvements therein can be subsequently made by those skilled in the art which are also intended to be encompassed by the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A system comprising:
a cover for a personal device;
a holder securing the personal device through the cover; and
an activation module providing an alarm when the cover and holder are disconnected.

17. The system of claim 16, wherein the activation module is at least partially within the cover or the holder.

18. The system of claim 16, wherein the activation module comprises a deactivation module disengaging the alarm.

19. The system of claim 16, wherein the activation module providing the alarm is activated when the cover and the holder are outside of a predetermined distance.

20. The system of claim 16, wherein the alarm comprises at least one of a speaker, vibrator, light and combination thereof.
